(19) United States
(12) Patent Application Publication
(10) Pub. No.: US 2024/0200936 A1
(43) Pub. Date: Jun. 20, 2024

(54) MODULATION UNIT FOR AN ENCODER

(71) Applicant: Ocado Innovation Limited, Hatfield (GB)

(72) Inventors: James Newton, Las Vegas, NV (US); James Wigglesworth, Las Vegas, NV (US)

(21) Appl. No.: 18/068,913

(22) Filed: Dec. 20, 2022

(51) Int. Cl. G01B 11/26

(52) U.S. Cl. CPC G01B 11/26

(57) ABSTRACT

The present disclosure concerns a modulation unit for an encoder. The modulation unit is configured to be movably supported between a receiver for converting the detection of electromagnetic radiation into an output signal and an emitter for emitting electromagnetic radiation in the direction of the receiver, and comprises a code section comprising alternating opaque and transparent segments, the opaque segments being configured, in use, to interrupt emitted electromagnetic radiation between the emitter and receiver and the transparent segments being configured, in use, to permit emitted electromagnetic radiation to impinge on the receiver according to the position of the modulation unit. The modulation unit further comprises a plurality of index segments, wherein each index segment is uniquely identifiable in dependence on the output signal so as to serve as a starting point from which to begin monitoring the position of the unit.

The present disclosure generally relates to a modulation unit for an encoder. Some aspects of the invention relate to the modulation unit, an encoder comprising the modulation unit, and a method for determining an absolute position of the modulation unit.

### BACKGROUND

FIG. 1 shows an example manipulator apparatus, generally designated by 100. The manipulator apparatus 100 includes a robotic manipulator 102 comprising a robotic arm 104, an end effector 106 and a motion subsystem 108. The motion subsystem 108 is communicatively coupled to the robotic arm 104 and end effector 106, and is configured to cause the robotic arm 104 and end effector 106 to move in accordance with actuation commands or control signals issued by a motion controller 110. The motion controller 110 forms part of the manipulator apparatus 100 and comprises a data processing apparatus 111, used to determine the control signals, a non-transitory computer- or processor-readable data carrier and bus (not shown), to which the data processing apparatus 111 and non-transitory processor-readable data carrier are communicatively coupled.

The manipulator apparatus 100 may be arranged to manipulate an object within a workspace to pack the object into a receiving space, such as a container (or “bin” or “tote”). For example, the manipulator apparatus 100 may be implemented in a picking station of an automated storage and retrieval system (ASRS). An ASRS typically includes multiple containers arranged to store items and one or more load-handling devices or automated guided vehicles (AGV) to retrieve one or more containers during fulfilment of a customer order. At a picking station, items are picked from or placed into the one or more retrieved containers. The one or more containers in the picking station may be considered as being storage containers or delivery containers. A storage container is a container which remains within the ASRS and holds eaches of products which can be transferred from the storage container to a delivery container. A delivery container is a container that is introduced into the ASRS empty and subsequently has a number of different products loaded into it. A delivery container may comprise one or more bags or cartons into which products may be loaded. A delivery container may be substantially the same size as a storage container. Alternatively, a delivery container may be slightly smaller than a storage container such that a delivery container may be nested within a storage container. The manipulator apparatus 100 can therefore be used at a picking station to pick an item from one container, e.g. a storage container, and place the item into another container, e.g. a delivery container.

The robotic arm 104 comprises a plurality of interconnected links 112, 114 that are configured to move relative to each other in order to carry out the manipulation of an object. A motor is provided at a joint 116 between the links 112, 114 to enable this movement, and a corresponding encoder is used to determine characteristics of the movement and, in some instances, the respective positions of the links 112, 114. It should be noted that, for ease of explanation, only two links 112, 144 and a single joint 116 are referenced in this example, but it will be appreciated that the robotic arm 104 would, in most cases, comprise numerous links connected by several joints, enabling the manipulation of an object within six degrees of freedom.

FIG. 2 provides a schematic illustration of a rotary encoder 200 suitable for use within the joint 116 of the robotic arm 104. This particular encoder 200 is based on an optical sensing method and is used to encode movement of a drive shaft 212 into a set of quadrature output signals, first and a second waveform signals 228a, 228b, which can then be interpreted by the data processing apparatus 111 of the motion controller 110. This type of encoder 200 is commonly referred to as a Sin/Cos incremental encoder and is favoured in applications, such as robotics, where high-resolution measurements are necessary. The general workings and features of the encoder 200 will already be familiar to the skilled person. T0hus, its operation is not described in great detail here, but only to the extent necessary to put the invention into practice. Briefly, the encoder 200 comprises an emitter 202, a receiver, generally designated as 204, and a modulation unit 208 movably supported between the emitter 202 and receiver 204. In this example, the modulation unit 208 comprises a disc or wheel 210 concentrically mounted on and rotatable with the drive shaft 212 as the shaft 212 is driven by an associated motor 214. The emitter 202 is configured to emit a beam 216 of electromagnetic radiation in the direction of the receiver 204, and the modulation unit 208 modulates the beam 216 with a code section 220 positioned between the emitter 202 and receiver 204. The code section 220 comprises alternating opaque and transparent segments 222, 224 defining a circular track 226 located near to the outer peripheral edge of the disc 210. The opaque segments 222 interrupt the beam 216 between the emitter 202 and receiver 204, while the transparent segments 224 permit the beam 216 to impinge on the receiver 204. The receiver 204 comprises two photoelectric sensors 204a, 204b that are configured to detect changes in the intensity of the transmitted beam 216 as the disc 210 rotates, causing the opaque and transparent segments 222, 224 to pass between the emitter 202 and sensors 204a, 204b, and to output the set of encoded signals 228a, 228b accordingly. The photoelectric sensors 204a, 204b are offset from each other by 90 electrical degrees with respect to the emitter 202, producing a phase difference in the generated output signals 228a, 228b. These signals 228a, 228b are then processed by the data processing apparatus 111 in order to ascertain information about the movement of the shaft 212. This information is then used to as the basis for determining and issuing, by the motion controller 110, further actuation commands to the motor 214. There are several known methods by which the data processing apparatus 111 could process the output signals 228a, 228b to extract information about the movement of the shaft 212, such as direction, incremental changes in position and speed at a specific instant in time. These methods will already be familiar to the skilled person, and so will not be described in detail here. It will, however, be understood that the direction with which the shaft 212 is rotating can be determined based on which of the first or second output signals 228a, 228b is leading the other due to their phase difference. The angular position of the disc 210 can be obtained from interpolating the output signals 228a, 228b based on a compound of a coarse and a fine angle measurement, where the coarse angle measurement is derived from an incremental line count of the number of periods 232 of the output signals 228a, 228b and the fine angle measurement is determined from the phase of the output signals 228a, 228b within the count based on x- and y-coordinates of a unit circle determined according to the respective functions of the output signals 228a, 228b.

With reference to FIG. 3, an absolute position of the drive shaft 212 may be determined by the inclusion of an index segment 234 on the modulation unit 208. The index segment 234 is a single transparent segment provided at a fixed location on the modulation unit 208, which in this embodiment, is separate from the code section 220. The index segment 234 serves as a reference point for the encoder 200, denoting a zero position for the shaft 212 and defining a starting point from which to begin monitoring the position of the shaft 212. In order to make use of the index segment 234, the encoder 200 may further comprise an additional emitter 236 and photoelectric sensor 204c positioned either side of the index segment 234. The emitter 236 is configured to emit a beam 238 of electromagnetic radiation in the direction of the photoelectric sensor 204c, and the modulation unit 208 modulates the beam 238 with the index segment 234 when it passes between the emitter 236 and photoelectric sensor 204c as the modulation unit 208 rotates. The photoelectric sensor 204c is configured to detect changes in the transmitted beam 238 as the index segment 234 traverses the space between the emitter 236 and photoelectric sensor 204c and output an index pulse 228c that is then processed by the data processing apparatus 230 in order to determine the zero position for the shaft 212. One issue with this sort of arrangement is that, upon start-up, the drive shaft 212 must, in some cases, almost fully rotate before the encoder 200 is able to identify the index segment 234, and hence determine the absolute position of the shaft 212. This can cause practical issues, some of which specifically arise when the encoder 220 is used in the joint 116 of a robotic arm 104, as illustrated in the series of images in FIGS. 4A-4D. As mentioned previously, upon start-up, the drive shaft 212 associated with the joint 116 could be required to almost fully rotate so that the corresponding encoder 200 can locate the index segment 234 and, in doing so, establish the zero position of the drive shaft 212. From this position, the position of the drive shaft 212 may be monitored. However, during this process, rotation of the drive shaft 212, of course, causes a corresponding rotation in an associated link 114, resulting in the link 114 sweeping through the workspace of the manipulator apparatus 100, as indicated by arrow 240. This increases the likelihood of the robotic arm 104 colliding with other objects within the workspace, resulting in damage to the robotic arm 104 and/or the objects. This potential for collisions is a particular concern when the workspace might occasionally be shared with an operative.

It is against this background that the invention has been devised.

### SUMMARY

The invention accordingly provides, in a first aspect, a modulation unit for an encoder, the modulation unit being configured to be movably supported between a receiver for converting the detection of electromagnetic radiation into an output signal and an emitter for emitting electromagnetic radiation in the direction of the receiver, the modulation unit comprising: a code section comprising alternating opaque and transparent segments, the opaque segments being configured, in use, to interrupt emitted electromagnetic radiation between the emitter and receiver and the transparent segments being configured, in use, to permit emitted electromagnetic radiation to impinge on the receiver according to the position of the modulation unit; and, a plurality of index segments, wherein each index segment is uniquely identifiable in dependence on the waveform shape of the output signal.

Optionally, the size of each index segment of the plurality of index segments differs with respect to each other and to the transparent segments.

Optionally, each pair of index segments is arranged in a distinctive spatial relationship with respect to other pairs of index segments.

Optionally, the spatial relationship between each pair of index segments is defined by a unique number of transparent segments.

Optionally, the spatial relationship between each pair of index segments on one section of the modulation unit is defined by a unique odd number of transparent segments and the spatial relationship between each pair of index segments on another section of the modulation unit is defined by a unique even number of transparent segments.

Optionally, the index segments form part of the code section.

Optionally, the size of the index segments differ with respect to the shape of the transparent segments.

Optionally, the modulation unit is a disc comprising a circular code section radially spaced from an axis of rotation.

Optionally, the modulation unit is a strip comprising a longitudinal code section.

Optionally, the modulation unit is made by additive manufacturing.

In a second aspect, there is provided a method of determining an absolute position of an encoder, the encoder comprising a receiver configured to detect electromagnetic radiation and convert it into an output signal; an emitter configured to emit electromagnetic radiation in the direction of the receiver; a data processing apparatus; and, a modulation unit according to the first aspect, wherein the method comprises determining, by the data processing apparatus, when a first index segment passes between the emitter and receiver in dependence on a first variation to the output signal; determining, by the data processing apparatus, when a second index segment passes between the emitter and receiver in dependence on a second variation to the output signal; determining, by the data processing apparatus, a spatial relationship between the first and second index segments based on the output signal between the first and second variations to the output signal; and, determining, by the data processing apparatus, an absolute position of the modulation unit based on the spatial relationship between the first and second index segments.

Optionally, determining the spatial relationship between the first and second index segments comprises counting the number of transparent segments based on the output signal between the first and second variations to the output signal.

Optionally, the first and second variations to the output signal are based on a second-order derivative of the output signal.

In a third aspect, the invention provides an encoder comprising: a receiver configured to detect electromagnetic radiation and convert it into an output signal; an emitter configured to emit electromagnetic radiation in the direction of the receiver; a modulation unit according to the first aspect; a data processing apparatus; and, a non-transitory processor-readable data carrier communicatively coupled to the data processing apparatus and which stores processor-executable instructions which, when executed by the data processing apparatus, cause the data processing apparatus to perform configured to perform the method of the second aspect.

In a fourth aspect, there is provided a computer program comprising processor-executable instructions which, when the program is executed by a computer, cause the computer to carry out the method of the second aspect.

In a fifth aspect, the invention provides a non-transitory processor-readable data carrier having stored thereon the computer program of the fourth aspect.

In a sixth aspect, the invention provides a robotic manipulator comprising an encoder according to the third aspect.

Within the scope of this application, it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment may be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

These and other aspects of the invention will now be described, by way of example only, with reference to the accompanying drawing, in which:

FIG. 1 is a schematic illustration of a robotic manipulator;

FIG. 2 is a schematic illustration of an incremental encoder for use in the robotic manipulator of FIG. 1;

FIG. 3 is a schematic illustration of an absolute position encoder;

FIGS. 4A-4D show a series of schematic illustrations of the robotic manipulator of FIG. 1 providing an example of a stroke through which a link of the robotic manipulator might make in order to establish an absolute position;

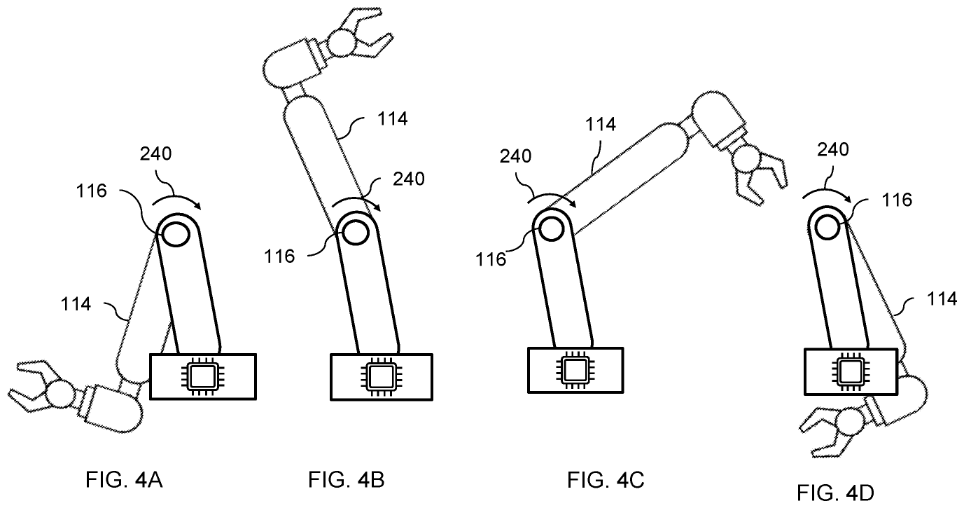

FIG. 5 is a schematic illustration of an encoder according to an embodiment of the invention for use in the robotic manipulator of FIG. 1;

FIGS. 6A-6C show example output signals from the encoder of FIG. 5 comprising different sequences of index pulses depending on the orientation of the encoder's modulation unit;

FIG. 7 is a schematic illustration of a modulation unit according to an embodiment of the invention;

FIGS. 8A and 8B show example output signals from an encoder using the modulation unit of FIG. 7;

FIG. 9 is a flow chart of a process carried out by a data processing apparatus of an encoder comprising the modulation unit of FIG. 7; and,

FIG. 10 is a schematic illustration of a modulation unit according to another embodiment of the invention.

### DETAILED DESCRIPTION

In the following description, some specific details are included to provide a thorough understanding of the disclosed examples. One skilled in the relevant art, however, will recognise that other examples may be practised without one or more of these specific details, or with other components, materials, etc., and structural changes may be made without departing from the scope of the invention as defined in the appended claims. Moreover, references in the following description to any terms having an implied orientation are not intended to be limiting and refer only to the orientation of the features as shown in the accompanying drawings. In some instances, well-known features or systems, such as data processors, sensors, storage devices, network interfaces, fasteners, electrical connectors, and the like are not shown or described in detail to avoid unnecessarily obscuring descriptions of the disclosed embodiments.

Unless the context requires otherwise, throughout the specification and the appended claims, the word “comprise” and variations thereof, such as, “comprises” and “comprising” are to be construed in an open, inclusive sense that is as “including, but not limited to.”

Reference throughout this specification to “one”, “an”, or “another” applied to “embodiment”, “example”, means that a particular referent feature, structure, or characteristic described in connection with the embodiment, example, or implementation is included in at least one embodiment, example, or implementation. Thus, the appearances of the phrase “in one embodiment” or the like in various places throughout this specification are not necessarily all referring to the same embodiment. Furthermore, the particular features, structures, or characteristics may be combined in any suitable manner in one or more embodiments, examples, or implementations.

It should be noted that, as used in this specification and the appended claims, the users forms “a”, “an”, and “the” include plural referents unless the content clearly dictates otherwise. It should also be noted that the term “or” is generally employed in its sense including “and/or” unless the content clearly dictates otherwise.

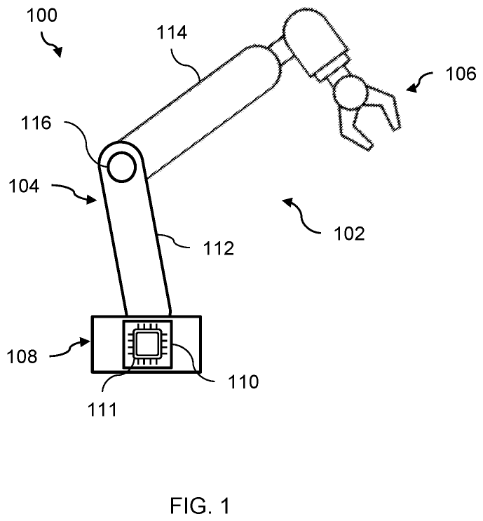

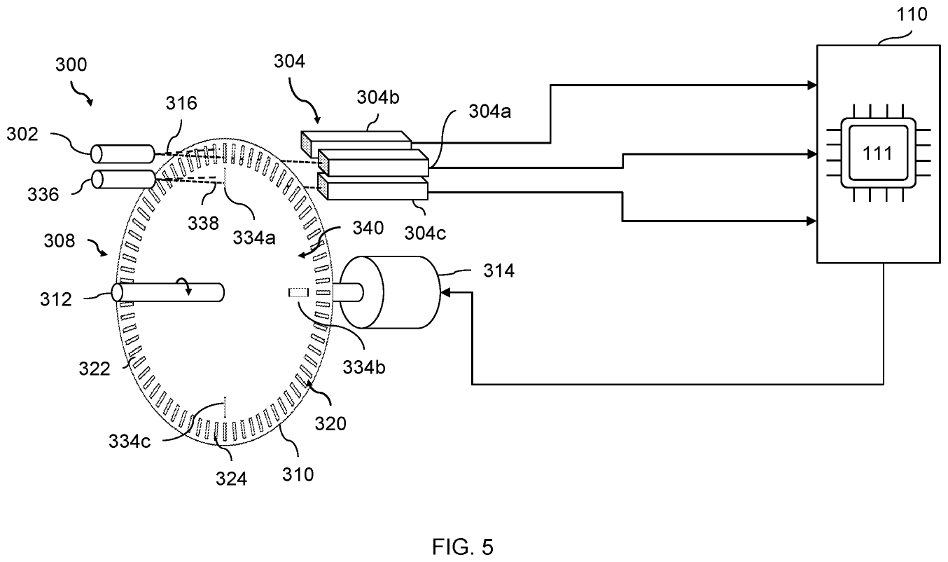

FIG. 5 shows an encoder 300 suitable for use in the robotic arm 104 of FIG. 1 that seeks to address or substantially mitigate the foregoing problem. The general operation and structure of the encoder 300 is substantially the same as the previously described encoders 100, 200. That is, the encoder 300 comprises a modulation unit 308, in the form of a disc 310, movably supported on a drive shaft 312 of a motor 314 between a receiver 304, comprising a plurality of photoelectric sensors 304a, 304b, 304c, for converting the detection of electromagnetic radiation 316, 338 into output signals and, in this example, a pair of emitters 302, 336 for emitting electromagnetic radiation 316, 338 in the direction of the receiver 304. The modulation unit 308 comprises a code section 320 comprising alternating opaque and transparent segments 322, 324. In use, the opaque segments 322 are configured to interrupt the electromagnetic radiation 316 between the first emitter 302 and first and second photoelectric sensors 304a, 304b, while the transparent segments 324 allow the electromagnetic radiation 316 to impinge on the first and second photoelectric sensors 304a, 304b. As the modulation unit 308 rotates, the photoelectric sensors 304a, 304b generate output signals that are processed by a data processing apparatus 111 of the motion controller 110 to ascertain information about the movement of the shaft 312.

However, in this example, the modulation unit 308 further comprises four transparent index segments 334a, 334b, 334c, 334d, although only three are visible in FIG. 5, each denoting a known location on the modulation unit 308 from which to begin monitoring the position of the shaft 312. The arrangement of the four index segments 334a; 334d defines a circular track 340, located radially inward of the code section 320, between the second emitter 336 and the third photoelectric sensor 304c. In this particular example, the index segments 334a; 334d are arranged at regular intervals around the track 340, but it should be noted that such an arrangement is not an essential requirement of the invention. The second emitter 336 is configured to emit a beam of electromagnetic radiation 338 in the direction of the third photoelectric sensor 304c, and the modulation unit 308 modulates the electromagnetic radiation 338 with the index segments 334a; 334d as it rotates. The photoelectric sensor 304c is configured to detect changes in the transmitted beam 338 as the index segments 334a; 334d traverses the space between the emitter 336 and photoelectric sensor 304c and output a waveform signal that is then processed by the data processing apparatus 111 in order to determine the position for the shaft 312. The determination of the absolute position of the shaft 312 is based on the known locations of the index segments 334a; 334d, but in order to differentiate one index segment 334a; 334d from another, each index segment 334a; 334d is sized differently when compared to the other index segments 334a; 334d so as to be uniquely identifiable from the duration of their respective index pulses within the output signal generated by the third photoelectric sensor 304c. This way, due to the arrangement of the index segments 334a; 334d, an absolute position of the drive shaft 312 can be determined within only a maximum of a quarter of a turn of the modulation unit 308, meaning that, when the encoder 300 is applied to a joint 116 of a robotic arm 104, the corresponding movement of an associated link 114 is greatly reduced. This, in turn, reduces the likelihood of collisions within the workspace of the robotic arm 104.

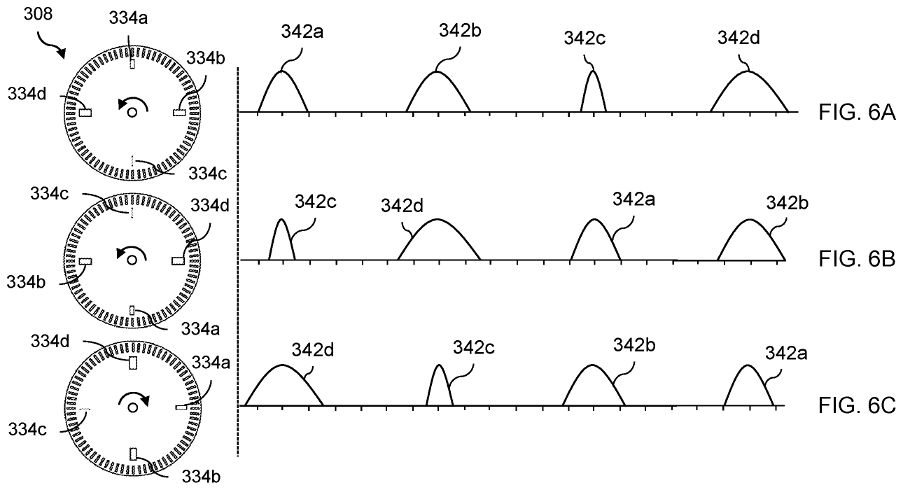

FIGS. 6A to 6C shows the modulation unit 308 of FIG. 5 alongside a series of example output signals from the third photoelectric sensor 304c showing how the sequence of the index pulses 342a; 342d might vary according to the position of the modulation unit 308 and the direction in which it rotates. Regarding FIG. 6A, for example, if a first index pulse 342a, associated with index segment 334a, is followed by a second index pulse 342b, corresponding to index segment 334b, it can be discerned that the modulation unit 308, and so the shaft 312 to which it is mounted, is rotating in an anticlockwise direction. Similarly, with reference to FIG. 6B, an anticlockwise rotation of the shaft 312 can also be ascertained if, for example, a first index pulse 342c, associated with index segment 334c, is followed by a second index pulse 342d that corresponds to index segment 334d. The sequence of index pulses 342a; 342d is reversed if the modulation unit 308 is rotated in a clockwise direction. So, not only does the use of a plurality of uniquely identifiable index segments 334a; 334d require smaller movements when seeking a known location on the modulation unit 308 from which to begin monitoring the position of the shaft 312, it also enables one to verify in which direction the modulation unit 308 has moved.

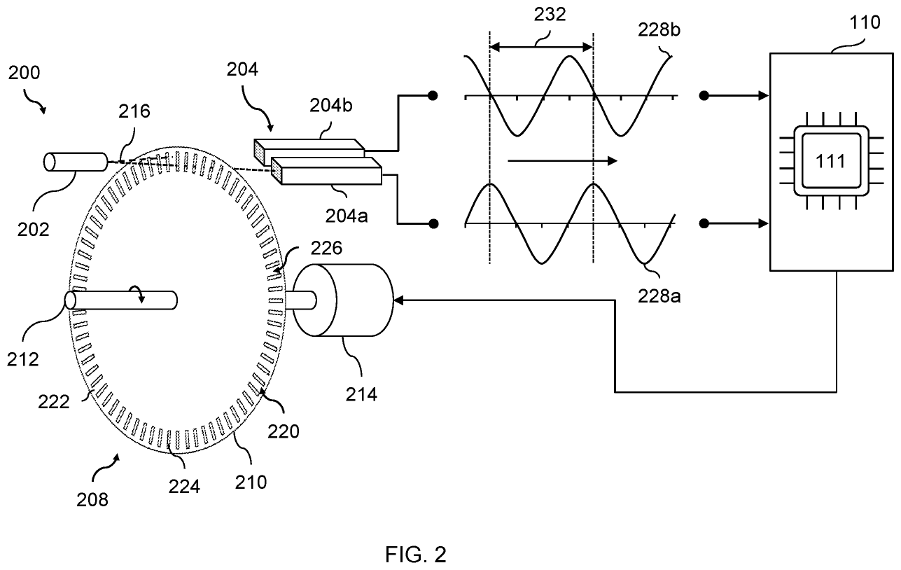

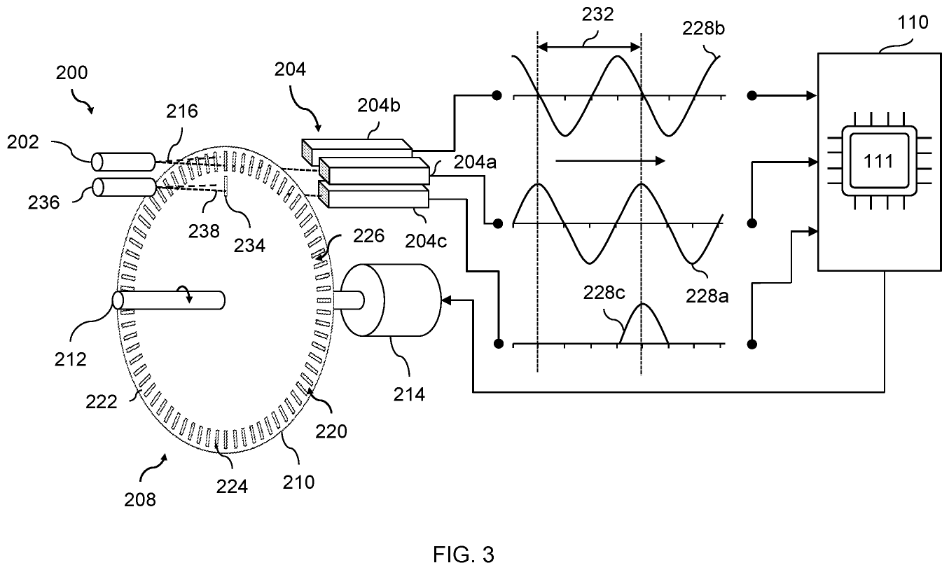

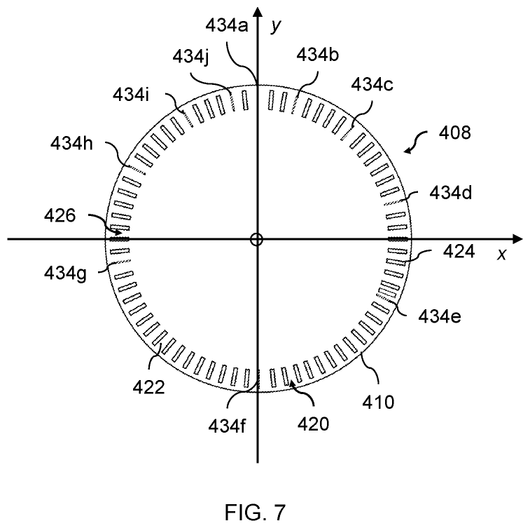

FIG. 7 shows another example of a modulation unit 408 suitable for use in an encoder 100, 200, 300 similar to those shown in FIGS. 2, 3 and 5. As in the other examples, the modulation unit 408 is in the form of a disc 410 configured to be movably supported between a receiver, for converting the detection of electromagnetic radiation into an output signal, and an emitter for emitting electromagnetic radiation in the direction of the receiver. The modulation unit 408 comprises a code section 420 comprising alternating opaque and transparent segments 422, 424. The opaque segments 422 are configured, in use, to interrupt emitted electromagnetic radiation between the emitter and receiver, whereas the transparent segments 424 are configured, in use, to permit emitted electromagnetic radiation to impinge on the receiver according to the position of the modulation unit 408. The modulation unit 408 further comprises a plurality of index segments 434a; 434j, each denoting a known location on the modulation unit 408 from which movement can be monitored, with each index segment 434a; 434j being uniquely identifiable in dependence on the output signal generated by the receiver. In this example, instead of forming their own track on the modulation unit 408, separate from the circular track 426 defined by the alternating opaque and transparent segments 422, 424, the index segments 434a; 434j form part of the code section 420, interspersed amongst the opaque and transparent segments 422, 424. In order that the index segments 434a; 434j can be distinguished from the transparent segments 424 of the code section 420, they are sized differently when compared to the transparent segments 424. However, rather than each index segment 434a; 434j being a different size when compared with the other index segments 434a; 434j, so that they might be internally distinguished from each other, pairs of index segments 434a; 434j are arranged in a distinctive spatial relationship with respect to other pairs of index segments 434a; 434j. Specifically, the spatial relationship between each pair of index segments 434a; 434j is defined by a unique number of transparent segments 424. For example, in this embodiment, the pair of index segments 434a, 434b are separated by two transparent segments 424. The spatial relationship between the pair of index segments 434g, 434h is defined by seven transparent segments 424, whereas the pair of index segments 434a, 434j is divided by a single transparent segment. In this way, the spatial relationships between pairs of index segments 434a; 434j can be used to distinguish one index segment 434a; 434j from the others when seeking to establish an absolute position of a shaft on which the modulation unit 408 is mounted.

Moreover, instead of using an increasing the number of transparent segments 424 to provide a distinguishing spatial relationship between each pair of index segments 434a, 434j around the entirety of the code section 420, it is preferable to divide the modulation unit 408 into two sections and define the spatial relationships between pairs of index segments 434a; 434j in one of the sections using unique odd numbers of transparent segments 424, while the spatial relationships in the other section are defined using unique even numbers of transparent segments 424. In the example provided, the spatial relationship between pairs of index segments 434a, 434b, 434c, 434d, 434e, 434f on the right side of the modulation unit 408, as it is viewed in FIG. 7, are defined by two, four, six, eight, and 12 transparent segments 424, whereas the spatial relationship between pairs of index segments 434f, 434g, 434h, 434i; 434j, 434a on the left side of the modulation unit 408 are defined by 15, seven, five, three, and one transparent segments 424. This novel arrangement of index segments 434a; 434j lessens the movement required of an associated shaft, and so of any associated links, when establishing its absolute position when compared to known encoders. It also can be used to determine, in a straightforward manner, whether or not one of the x- or y-coordinates of the unit circle is positive or negative when determining the angular position of modulation unit 408. In the current example, the spatial relationships between pairs of index segments 434a; 434i on the right side of the modulation unit 408 are defined by even numbers of transparent segments 424, whereas the spatial relationship between pairs of index segments 434a; 434i on the left side of the modulation unit 408 are defined by odd numbers of transparent segments 424. With this arrangement, therefore, if it is determined that a spatial relationship is defined by an even number of transparent segments 424, one can easily determine from this that the x-coordinate of the angular position of the modulation unit 408 is positive. However, if it is determined that the spatial relationship is defined by an odd number of transparent segments 424, then the x-coordinate of the angular position of the modulation unit 408 is negative. In other embodiments, the top and bottom halves of the modulation unit 408 may be distinguished by spatial relationships being defined by either odd or even numbers of transparent segments. In that case, it would be easy to ascertain whether the y-coordinate of the angular position of the modulation unit 408 is positive or negative based on that distinction.

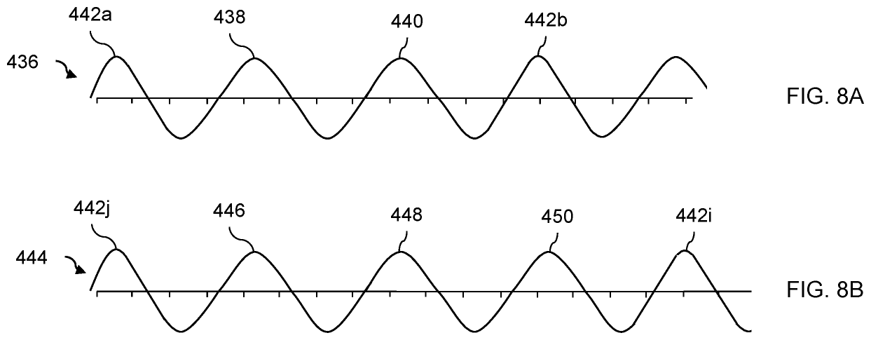

The unique spatial relationship between pairs of index segments 434a; 434i are clearly manifested in the output signals of the receiver, as illustrated in FIGS. 8A and 8B, which may then be processed by a data processing apparatus 111 to determine an absolute position of the modulation unit 408 from which to start monitoring its movement. FIG. 8A shows an example output signal 436 as the pair of index segments 434a, 434b pass between the emitter and receiver. In this instance, the output signal 436 comprises two index pulses 442a, 442b corresponding to index segments 434a, 434b, respectively. The index pulses 442a, 442b are separated by two other pulses 438, 440 that correspond to the two transparent segments 424 defining the spatial relationship between the index segments 434a, 434b. FIG. 8B shows an example output signal 444 of the receiver as the pair of index segments 434j, 434i pass between the emitter and receiver. As with the previous example, the output signal 444 comprises two index pulses 442j, 442i, respectively corresponding to index segments 434j, 434i. In this instance, however, three other pulses 446, 448, 450, corresponding to the three transparent segments 424 that define the spatial relationship between the index segments 434j, 434i, separate the two index pulses 442j, 442i.

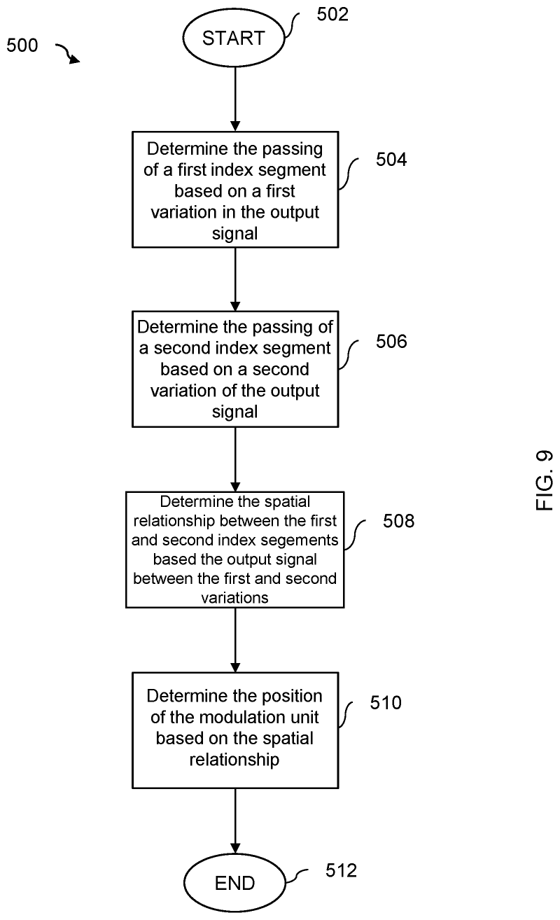

During the process of analysing output signals, such as output signal 436, the data processing apparatus 111 is configured to carry out the method 500 illustrated in FIG. 9. The method 500 starts at step 502 and proceeds to step 504 where the data processing apparatus 111 determines when a first index segment 434a passes between the emitter and receiver in dependence on a first variation to the output signal 436. The waveforms made by the transparent segments 424 differ from those produced by the index segments 434a; 434i. This is due to the fact that the index segments 434a; 434i are a different size when compared to the transparent segments 424. This difference in size can, however, be subtle, resulting in very similar waveform shapes. For example, with reference to FIG. 8A, the waveform shapes of index pulses 442a, 442b are very similar to the other two pulses 438, 440 produced by transparent segments 424. In order to be able to compare the waveform shapes 438, 440, 442a, 442b, the data processing apparatus 111 is configured to determine the second-order derivative of the output signal 436 and monitor the waveform shapes. If it is determined that the waveform shape of one pulse varies or differs from the waveform shape of the pulse that preceded it and the pulse succeeding it, then the one pulse is considered to be an index pulse.

Having established the passing of a first index segment 434a, the method 500 then moves to step 506 where the data processing apparatus 111 determines the passing of a second index segment 434b between the emitter and receiver in dependence on a second variation to the output signal 436. In this instance, the data processing apparatus 111 continues to monitor waveform shapes based on a second-order derivative of the output signal 436 and identify a variation in the waveform shape of another pulse with respect to the waveform shapes of its neighbouring pulses, and mark the other pulse a second index pulse as appropriate.

The method 500 continues to step 508 in which the data processing apparatus 111 determines the spatial relationship between the first and second index segments 434a, 434b based on the output signal 436 between the first and second variations to the output signal 436. This is done by counting the number of pulses between the first and second index pulses. In the case of output signal 436, this means counting the two pulses 438, 440 that separate index pulses 442a, 442b. Once the spatial relationship between the index pulses has been established, the method 500 continues to step 510, where the data processing apparatus 111 determines an absolute position of the modulation unit 408 based on the spatial relationship between the first and second index segments. In the current example, the data processing apparatus 111, having established in the previous step 508 that the spatial relationship between the index pulses 442a, 442b is defined by two pulses 438, 440, determines, based on this separation, that the two index pulses 442a, 442b correspond to index segments 434a, 434b respectively, either one of which could be used as a known starting point from which to begin monitoring the angular position of the modulation unit 408. Following this, the method 500 proceeds to step 512 where it is ended.

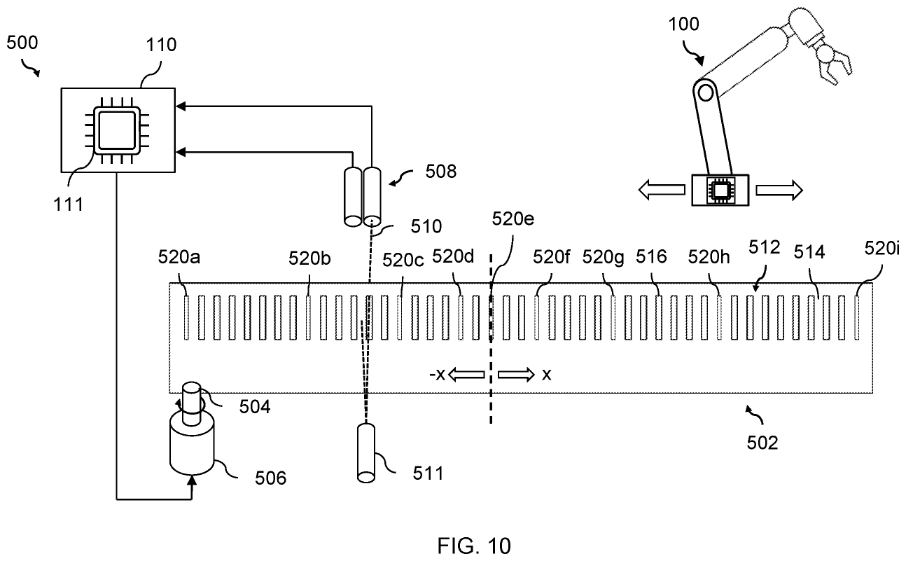

FIG. 10 shows an example of a linear encoder 500. The general operation and structure of the encoder 500 is substantially the same as those previously described insofar that it comprises a modulation unit 502 configured to be driven by a drive shaft 504 of a motor 506. In this example, however, the modulation unit 502 is a linear modulation unit, used to ascertain position in a single dimension, such as a lateral position of the manipulator apparatus 100. Like the rotary modulation units of the previous examples, it too is positioned between a receiver 508, for converting the detection of electromagnetic radiation 510 into output signals, and an emitter 511 for emitting electromagnetic radiation 510 in the direction of the receiver 508. The modulation unit 502 comprises a longitudinal code section 512 having alternating opaque and transparent segments 514, 516. In use, the opaque segments 514 are configured to interrupt the electromagnetic radiation 510 between the emitter 511 and receiver 508, while the transparent segments 516 allow the electromagnetic radiation 510 to impinge on the receiver 508. As the modulation unit 502 moves, the receiver 508 generates output signals that are processed by a data processing apparatus 111 of the motion controller to establish information about the movement of the shaft 312. The modulation unit 502 further comprises a plurality of index segments 520a; 520i interspersed amongst the opaque and transparent segments 514, 516. Each index segment 520a; 520i denotes a known location on the modulation unit 502 from which movement can be monitored, with each index segment 520a; 520i being uniquely identifiable in dependence on the output signal generated by the receiver 508 using the process shown in FIG. 9. To that end, each pair of index segments 520a; 520i is arranged in a distinctive spatial relationship with respect to the other pairs. Specifically, the spatial relationship between each pair of index segments 520a; 520i is defined by a unique number of transparent segments 516. For example, in this embodiment, the pair of index segments 520a, 520b are separated by seven transparent segments 516. The spatial relationship between the pair of index segments 520e, 520f is defined by two transparent segments 516, whereas the pair of index segments 520g, 520h is divided by six transparent segments 516. In this way, the spatial relationships between pairs of index segments 520a; 520i can be used to distinguish one index segment 520a; 520i from the others when seeking to establish an absolute position of the drive shaft 504. It is preferable to divide the modulation unit 502 into two sections (−x, x) and define the spatial relationships between pairs of index segments 520a; 520e in one of the sections (−x) using unique odd numbers of transparent segments 516, while the spatial relationships in the other section (x) are defined using unique even numbers of transparent segments 516. In the example provided, the spatial relationship between pairs of index segments 520a; 520e on the left side of the modulation unit 502, as it is viewed in FIG. 10, are defined by seven, five, three, and one transparent segment 516, whereas the spatial relationship between pairs of index segments 520e; 520i on the right side of the modulation unit 502 are defined by two, four, six and eight transparent segment 516. This way, it is easy to correlate the position of the drive shaft 504 and the corresponding section (−x, x) of the modulation unit 502.

The foregoing description has been presented for the purpose of illustration only and is not intended to be exhaustive or to limit the invention to the precise embodiments disclosed. It will be appreciated that modifications and variations can be made to the described embodiments without departing from the scope of the invention as defined in the appended claims.

1. A modulation unit for an encoder, the modulation unit being configured to be movably supported between a receiver for converting the detection of electromagnetic radiation into an output signal and an emitter for emitting electromagnetic radiation in the direction of the receiver, the modulation unit comprising:
a code section comprising alternating opaque and transparent segments, the opaque segments being configured, in use, to interrupt emitted electromagnetic radiation between the emitter and receiver and the transparent segments being configured, in use, to permit emitted electromagnetic radiation to impinge on the receiver according to the position of the modulation unit; and,
a plurality of index segments, wherein each index segment is uniquely identifiable in dependence on the output signal.

2. A modulation unit according to claim 1, wherein the size of each index segment of the plurality of index segments differs with respect to each other and to the transparent segments.

3. A modulation unit according to claim 1, wherein each pair of index segments is arranged in a distinctive spatial relationship with respect to other pairs of index segments.

4. A modulation unit according to claim 3, wherein the spatial relationship between each pair of index segments is defined by a unique number of transparent segments.

5. A modulation unit according to claim 4, wherein the spatial relationship between each pair of index segments on one section of the modulation unit is defined by a unique odd number of transparent segments and the spatial relationship between each pair of index segments on another section of the modulation unit is defined by a unique even number of transparent segments.

6. A modulation unit according to claim 1, wherein the index segments form part of the code section.

7. A modulation unit according to claim 3, wherein the size of the index segments differ with respect to the shape of the transparent segments.

8. A modulation unit according to claim 1, wherein the modulation unit is a disc comprising a circular code section radially spaced from an axis of rotation.

9. A modulation unit according to claim 1, wherein the modulation unit is a strip comprising a longitudinal code section.

10. A modulation unit according to claim 1, wherein the modulation unit is made by additive manufacturing.

11. A method of determining an absolute position of an encoder, the encoder comprising:
a receiver configured to detect electromagnetic radiation and convert it into an output signal;
an emitter configured to emit electromagnetic radiation in the direction of the receiver;
a data processing apparatus; and
a modulation configured to be movably supported between the and the emitter, the modulation unit comprising: a code section comprising alternating opaque and transparent segments, the opaque segments being configured, in use, to interrupt emitted electromagnetic radiation between the emitter and the receiver and the transparent segments being configured, in use, to permit emitted electromagnetic radiation to impinge on the receiver according to the position of the modulation unit; and a plurality of index segments, wherein each index segment is uniquely identifiable in dependence on the output signal, and wherein each pair of index segments is arranged in a distinctive spatial relationship with respect to other pairs of index segments;
wherein the method comprises:
determining, by the data processing apparatus, when a first index segment passes between the emitter and receiver in dependence on a first variation to the output signal;
determining, by the data processing apparatus, when a second index segment passes between the emitter and receiver in dependence on a second variation to the output signal;
determining, by the data processing apparatus, a spatial relationship between the first and second index segments based on the output signal between the first and second variations to the output signal; and,
determining, by the data processing apparatus, an absolute position of the modulation unit based on the spatial relationship between the first and second index segments.

12. A method according to claim 11, wherein determining the spatial relationship between the first and second index segments comprises counting the number of transparent segments based on the output signal between the first and second variations to the output signal.

13. A method according to claim 11, wherein the first and second variations to the output signal are based on a second-order derivative of the output signal.

14. An encoder comprising:
a receiver configured to detect electromagnetic radiation and convert it into an output signal;
an emitter configured to emit electromagnetic radiation in the direction of the receiver;
a modulation unit configured to be movably supported between the and the emitter, the modulation unit comprising: a code section comprising alternating opaque and transparent segments, the opaque segments being configured, in use, to interrupt emitted electromagnetic radiation between the emitter and the receiver and the transparent segments being configured, in use, to permit emitted electromagnetic radiation to impinge on the receiver according to the position of the modulation unit; and a plurality of index segments, wherein each index segment is uniquely identifiable in dependence on the output signal, and wherein each pair of index segments is arranged in a distinctive spatial relationship with respect to other pairs of index segments;
a data processing apparatus; and,
a non-transitory processor-readable data carrier communicatively coupled to the data processing apparatus and which stores processor-executable instructions which, when executed by the data processing apparatus, cause the data processing apparatus to perform a method, the method comprising:
determining, by the data processing apparatus, when a first index segment passes between the emitter and receiver in dependence on a first variation to the output signal;
determining, by the data processing apparatus, when a second index segment passes between the emitter and receiver in dependence on a second variation to the output signal;
determining, by the data processing apparatus, a spatial relationship between the first and second index segments based on the output signal between the first and second variations to the output signal; and,
determining, by the data processing apparatus, an absolute position of the modulation unit based on the spatial relationship between the first and second index segments.

15-17. (canceled)
